(19) United States
(12) Patent Application Publication
(10) Pub. No.: US 2019/0191535 A1
(43) Pub. Date: Jun. 20, 2019

(54) LED-FILAMENT AND LIGHTING DEVICE COMPRISING THE LED-FILAMENT

(71) Applicant: SIGNIFY HOLDING B.V., EINDHOVEN (NL)

(72) Inventors: RIFAT ATA MUSTAFA HIKMET, EINDHOVEN (NL); TIES VAN BOMMEL, HORST (NL)

(21) Appl. No.: 16/328,314

(22) PCT Filed: Aug. 30, 2017
(86) PCT No.: PCT/EP2017/071818

§ 371 Date: Feb. 26, 2019

(30) Foreign Application Priority Data
Sep. 5, 2016 (EP) 16187238.7
Sep. 20, 2016 (EP) 16189590.9

(51) Int. Cl. H05B 37/02; F21K 9/232; F21V 23/00

(52) U.S. Cl. CPC H05B 37/0272; F21Y 2115/10; F21V 23/003; F21K 9/232

(57) ABSTRACT

A LED-filament (11) is provided. The LED-filament comprises a substrate (12) having an elongated body with an extension along an elongation axis (A); a plurality of LEDs (13) mechanically coupled to the substrate; and a communication element (14) mechanically coupled to the LED-filament, the communication element is configured for wireless communication. Also a lighting device is provided. The lighting device comprises the LED-filament (11); and a controller (16) configured to control the plurality of LEDs with respect to characteristics of light emitted by the plurality of LEDs, wherein the communication element is communicatively coupled to the controller, and wherein the controller is configured to receive a control signal from the communication element for controlling operation of the plurality of LEDs.

### FIELD OF THE INVENTION

The present invention relates to a LED-filament for a lighting device.

### BACKGROUND OF THE INVENTION

The use of solid state lighting devices, such as light-emitting diodes, LEDs, for illumination purposes continues to attract attention. Compared to incandescent lamps, fluorescent lamps, gas discharge lamps, etc., solid state based light sources may provide numerous advantages such as, inter alia, longer operational life, reduced power consumption, higher efficacy, less heat generation, green environmental products (i.e. not including mercury). Solid state lighting devices such as LEDs are employed in a wide range of lighting applications, such as, for example, general lighting. LEDs are advantageous since they may allow for a relatively simple control of the emitted light for example with respect to dimming and color setting. In a lighting system comprising LEDs, or other solid state lighting devices, such control may be realized by means of the lighting system receiving control signals for controlling the operation of the LEDs by way of wireless radio frequency, RF, communication. The control signals may for example be transmitted by some control device or lighting system controller capable of wireless communication. The wireless RF communication capability of the lighting system may be implemented by employing an RF antenna, which for example may be positioned on the surface of a heat sink, as disclosed in US 2011/0006898 A1. This may allow for the lighting system to be operated in conjunction with wireless home automation systems or the like. It is generally desired that the antenna has a well-defined position, is mechanically supported, and can be fabricated with relative ease. It is also generally desired that the antenna does not interfere with the optical path of the lighting device(s), or that it does so only to a relatively small extent.

DE 202015100715 U1 discloses an encapsulating substrate for LEDs, which comprises a substrate. An electrode lead-out wire is provided at at least one end of the substrate. The substrate is overall spiral-shaped and the edge is a smooth curve or a broken line formed by joining a plurality of straight lines at their ends or a combination thereof.

WO 2015/060072 A1 discloses an illumination device with an illumination module, a wireless communication module, and a power supply unit. The inductive reactance of coils at a carrier frequency is set to a high impedance, whereby a circuit of the illumination module functions, due to a first antenna part and a second antenna part, as a dipole antenna circuit in response to a high-frequency signal, and functions as a circuit for causing light-emitting elements to emit light in response to a DC-component signal.

US 2011/006898 A1 discloses a merchandise control device which can be attached to a light emitting diode (LED) light bulb. A radio frequency identification (RFID) circuit located within the LED light bulb is configured to respond to an interrogating radio frequency (RF) signal at a point of sale. An antenna is provided on an external surface of the LED light bulb, or on a sheet attached to the LED light bulb, and has an electrical connection that communicates the RF signal to the RFID device. The RFID device is configured to enable function of the LED light bulb upon receiving a security code from the RF signal that matches a security code stored in the RFID device.

US 2008/308641 A1 discloses a smart card which has a multi-layer substrate, a transponder module which is disposed in a first layer of the multi-layer substrate, a first antenna which is disposed in the first layer of the multi-layer substrate, and a second antenna which is disposed in a second layer of the multi-layer substrate. A switch and a capacitor in is series with the second antenna. The first antenna may be tuned to a different frequency than the second antenna. An RFID chip and antenna in a mold mass is disposed in a recess in the first layer of a substrate, behind a hologram which is disposed on the first layer of the substrate. The switch for the second antenna is disposed under the RFID chip. A layer of ferrite material is disposed between the hologram and the RFID chip. LEDs are disposed behind the hologram.

### SUMMARY OF THE INVENTION

In view of the above discussion, a concern of the present invention is to achieve a lighting device having an antenna that has a well-defined position in the lighting device, is mechanically supported in the lighting device, does less interfere with the electrical connection of the LEDs i.e. wiring for powering the LEDs and/or that does not, or only to a relatively small extent, interfere with the optical path of the lighting device.

To address at least one of these concerns and other concerns, a lighting device in accordance with the independent claim is provided. Preferred embodiments are defined by the dependent claims.

According to a first aspect, this and other objects are achieved by providing a LED-filament. The LED-filament comprises a substrate having an elongated body with an extension along an elongation axis, a plurality of LEDs mechanically coupled to the substrate; wiring for powering the plurality of LEDs, and a communication element mechanically coupled to the LED-filament, the communication element is configured for wireless communication, and wherein the communication element is different from the wiring.

By means of the communication element being mechanically coupled to the LED-filament the communication element may not interfere with the optical path of the LED-filament, or only do so to a relatively small extent or degree. By means of the communication element being mechanically coupled to the LED-filament, the communication element may have a well-defined position. Further, the LED-filament may be manufactured with relative ease. Further, by means of the communication element being different from the wiring, the communication element does less interfere with the electrical connection of the LEDs such that the communication element provides improved signal sending and signal receiving characteristics.

The communication element may for example be arranged for, or capable of, radio frequency, RF, wireless communication. Hence, the communication element may comprise at least one RF antenna element. However, the communication element is not limited thereto. In alternative or in addition the communication element may for example comprise at least one infrared antenna.

The communication element may be arranged on the substrate. By this the LED-filament may be manufactured with relative ease. For example, the communication element may be printed onto the substrate. Moreover, by arranging the communication element on the substrate a well-defined position for the communication element may be achieved.

The substrate may be transparent. A transparent substrate allows light escaping the LED-filament at all angles.

The substrate may comprise first and second surfaces, wherein the plurality of LEDs may be arranged on the first surface of the substrate and the communication element may be arranged on the second surface of the substrate. By this blocking of light being emitted by the plurality of LEDs may be minimized.

The first and second surfaces may be opposite each other. By this blocking of light being emitted by the plurality of LEDs may be minimized.

The plurality of LEDs and the communication element may be arranged on a common surface of the substrate. An easy way of manufacturing the LED-filament is provided.

The plurality of LEDs may be arranged along a line having an extension parallel with the elongation axis.

The communication element may be positioned not directly opposite any one of the plurality of LEDs, or not on top of any one of the plurality of LEDs. By this blocking of light being emitted by the plurality of LEDs may be minimized.

The communication element may have an extension parallel with the elongation axis.

The communication element may at least partly surround the plurality of LEDs. By this a communication element having an extension being longer than the extension of the LED-filament is provided.

The communication element may have a meandering extension along the elongation axis. By this a communication element having an extension being longer than the extension of the LED-filament is provided.

The substrate may comprise a groove, a through hole, or a protrusion. The communication element may be arranged in the groove, in through hole, or on the protrusion. By this a well-defined position for the communication element may be achieved. Moreover, a well defined support for the communication element is provided.

The LED-filament may further comprise an encapsulation encapsulating the substrate and the plurality of LEDs. The communication element may be integrated within the encapsulation. By integrating the communication element within the encapsulation the communication element may be made non-viable, moreover the communication element will be protected. The communication element may be partly integrated into the encapsulation. The communication element may be arranged on the encapsulation. By partly integrating or by arranging the communication element on the encapsulation the communication element may be arranged on the encapsulation is a subsequent processing step as the production of the encapsulation itself Hence, the communication element may be mounted after the wiring construction of the LEDs.

The communication element may be wounded around the encapsulation. By this a communication element having an extension being longer than the extension of the LED-filament is provided.

According to a second aspect a lighting device is provided. The lighting device comprises a LED-filament according to the above and a controller configured to control the LED-filament with respect to characteristics of light emitted by the LED-filament, wherein the communication element is communicatively coupled to the controller, and wherein the controller is configured to receive a control signal from the communication element for controlling operation of the LED-filament.

The above mentioned features of the LED-filament, when applicable, apply to this second aspect as well. In order to avoid undue repetition, reference is made to the above.

Moreover, the lighting device may comprise a plurality of LED-filaments according to the above, wherein the communication elements of the plurality of LED-filaments are interconnected forming a common communication element. By this a communication element having an extension being longer than the individual LED-filaments is provided.

The above mentioned features of the LED-filament, when applicable, apply to this second aspect as well. In order to avoid undue repetition, reference is made to the above.

A further scope of applicability of the present invention will become apparent from the detailed description given below. However, it should be understood that the detailed description and specific examples, while indicating preferred embodiments of the invention, are given by way of illustration only, since various changes and modifications within the scope of the invention will become apparent to those skilled in the art from this detailed description.

Hence, it is to be understood that this invention is not limited to the particular component parts of the device described or steps of the methods described as such device and method may vary. It is also to be understood that the terminology used herein is for purpose of describing particular embodiments only, and is not intended to be limiting. It must be noted that, as used in the specification and the appended claim, the articles “a,” “an,” “the,” and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

This and other aspects of the present invention will now be described in more detail, with reference to the appended drawings showing embodiment(s) of the invention. The figures should not be considered limiting the invention to the specific embodiment; instead they are used for explaining and understanding the invention.

As illustrated in the figures, the sizes of layers and regions are exaggerated for illustrative purposes and, thus, are provided to illustrate the general structures of embodiments of the present invention. Like reference numerals refer to like elements throughout.

FIG. 1 is a schematic side view of a lamp comprising a lighting device.

FIGS. 2A-D are schematic sectional views of LED-filaments in accordance with respective embodiments of the present invention. Each of FIGS. 2A-D illustrates a cross section of the respective LED-filament in a plane perpendicular to an elongation axis of the respective LED-filament.

FIGS. 3A-D are schematic side views of a LED-filaments in accordance with respective embodiments of the present invention.

FIGS. 4A-C are schematic sectional views of LED-filaments in accordance with respective embodiments of the present invention. Each of FIGS. 4A-C illustrates a cross section of the respective LED-filament in a plane perpendicular to an elongation axis of the respective LED-filament.

FIGS. 5A-C are schematic sectional views of LED-filaments in accordance with respective embodiments of the present invention. Each of FIGS. 5A-C illustrates a cross section of the respective LED-filament in a plane perpendicular to an elongation axis of the respective LED-filament.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

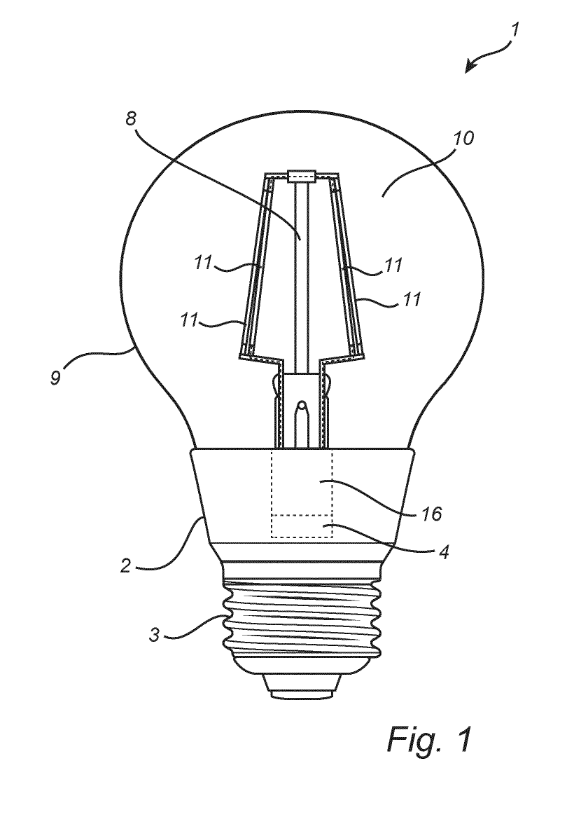

FIG. 1 is a schematic side view of a lighting device 1. The lighting device 1 comprises a LED-filament 11 and a controller 6.

In FIG. 1 the lighting device 1 comprises four LED-filaments 11. However, any number of LED-filaments 11 may be used. Hence, the lighting device 1 may comprise one or more LED-filaments 11. Moreover, not all of the LED-filaments need to be LED-filaments in accordance with the present invention.

Moreover, it is to be understood that the shape of the LED-filaments 11 illustrated in FIG. 1 is according to an example and that other shapes and geometrical configurations of the LED-filaments 11 are possible. For example, the LED-filament 11 may be at least in part straight, or substantially straight. Also, curved configurations of the LED-filament 11 are possible. For example, the LED-filament 11 may be shaped according to a coil. Possibly, the LED-filament 11 may be arranged such that it comprises one or more portions or segments wherein the LED-filament 11 is straight, or substantially straight, and one or more other portions or segments wherein the LED-filament 11 is curved.

As known in the art, the lighting device 1 may include circuitry 4 capable of converting electricity from a power supply to electricity suitable to operate or drive the LED-filaments 11, the controller 6 and/or power any other electrical components that may be included in the lighting device 1. The circuitry 4 is connected to the controller 6. It is to be understood that the circuitry 4 is illustrated only schematically in FIG. 1. The circuitry 4 may be capable of at least converting between Alternating Current and Direct Current and converting voltage into a suitable voltage for operating or driving the LED-filament 11, the controller 6 and/or any other electrical components that may be included in the lighting device 1. The circuitry 4 may include electronics such as a driver and/or wiring for conveying electricity to the LED-filament 11, the controller 6 and/or any other electrical components that may be included in the lighting device 1.

The lighting device 1 may further comprise an at least in part light-transmissive surface structure 9. The surface structure 9 in part defines a space 10 in which the LED-filament 11 are arranged, such that the surface structure 9 encloses the LED-filament 11. As illustrated in FIG. 1, the surface structure 9 may be pear-shaped, although it is to be understood that the surface structure 9 may in principle have any shape, such as, for example, tube-shaped. Light emitted from the LED-filaments 11 may be output from the lighting device 1 through the surface structure 9, by virtue of it being at least in part light-transmissive.

The surface structure 9 may for example be made of, at least in part, glass. The surface structure may e.g. be an envelope. For example fused silica glass (vitreous silica glass), soda-lime-silica glass (window glass), sodium borosilicate glass (pyrex), lead-oxide glass (crystal glass), aluminosilicate glass, or oxide glass. In alternative or in addition, the surface structure 9 may be made of, at least in part, sapphire and/or transparent or translucent ceramic, or comprise a ceramic part or portion such as a ceramic ring. Yet alternatively or in addition, the surface structure 9 may be made of, at least in part, plastic. For example, the surface structure 9 may be made from PMMA, PC, and/or PET.

The space 10 defined by the surface structure 9 may at least in part be fluidly sealed and enclosed. The space 10 may include or be filled with a thermally conductive fluid. The thermally conductive fluid may for example be a gas such as air or a gas including helium and/or hydrogen.

The lighting device 1 may further comprise a support structure 8, which may provide support for the LED-filaments 11 within the space 10. Such a support structure 8 may for example include a stem and/or support wires similar to what may be used in a conventional incandescent light bulb. For example, the stem may support the support wires which may be connected to the stem, and the support wires may be connected or coupled to the LED-filaments 11 at one or more locations on the LED-filaments 11.

The lighting device 1 may further comprise a base portion 2. The surface structure 9 may be coupled to the base portion 2. The connection may for example be made by means of a glue connection. The controller 6 may be arranged within the base portion 2. At least part of the circuitry 4 may be arranged within the base portion 2.

The lighting device 1 may be included in or constitute a LED bulb or retrofit lamp which is connectable to a lamp or luminaire socket by way of some appropriate connector 3. For example an Edison screw, a bayonet fitting, or another type of connector suitable for the lamp or luminaire known in the art. The connector 3 may be connected to the base portion 2.

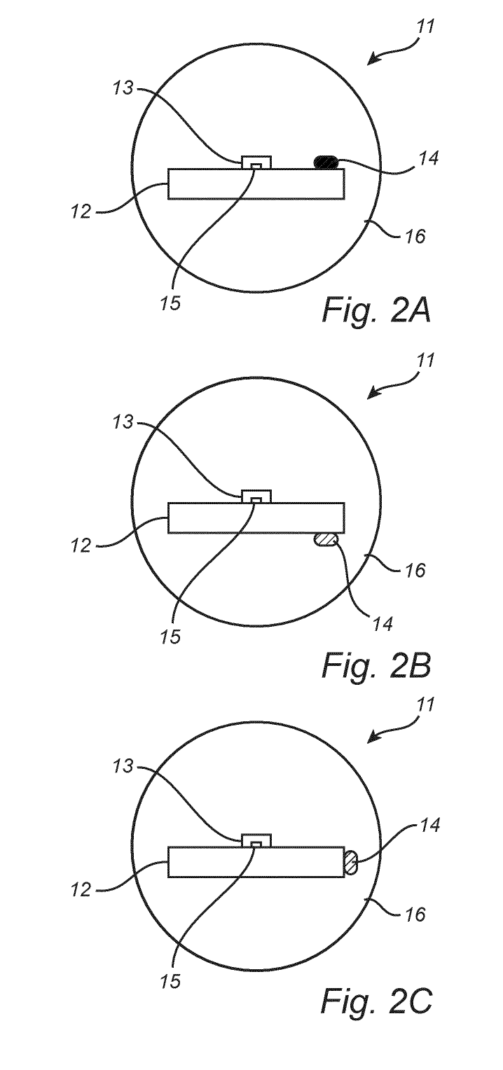

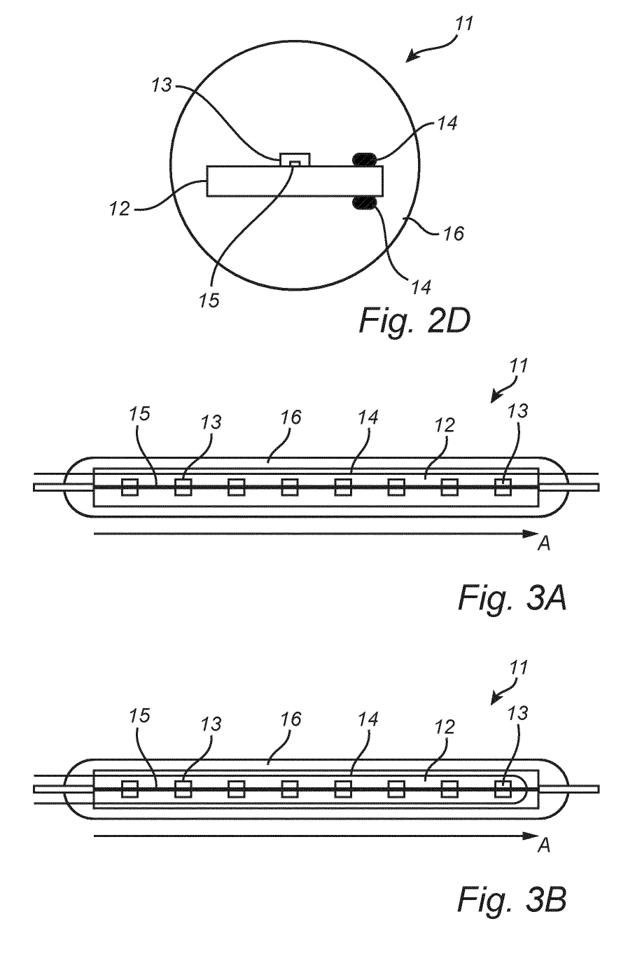

With reference to FIGS. 2A-D, 3A-D, 4 A-C, and 5 A-C different embodiments of LED-filament 11 according to the present invention will be discussed.

The LED-filament 11 according to the present invention comprises a substrate 12, a plurality of LEDs 13 and a communication element 14.

The substrate 12 may be transparent. A transparent substrate allows light escaping the LED-filament 11 at all angles. The substrate 12 comprises an elongated body with an extension along an elongation axis A. The elongation axis A of the substrate 12 may be at least in part straight, or substantially straight. However, it is to be understood that the elongation axis of the substrate 12 may be at least in part curved. For example, the substrate 12, and thus the LED-filament 11, may be shaped according to a coil. The substrate 12 may be arranged such that it comprises one or more portions or segments wherein the elongation axis of the substrate 12 is straight, or substantially straight, and one or more other portions or segments wherein the elongation axis of the substrate 12 is curved.

The plurality of LEDs 13 is mechanically coupled to the substrate. The plurality of LEDs 13 may be arranged along a line having an extension parallel with the elongation axis A of the substrate 12. The plurality of LEDs 13 may be powered via wiring 15. The wiring 15 may form part of the circuitry 4. The wiring 15 may e.g. comprise an electrically conductive track. The plurality of LEDs 13 is configured to emit light when operated or activated. The plurality of LEDs 13 may be configured to emit light having substantially the same spectral distribution. Alternatively, the plurality of LEDs 13 may be configured to emit light having different spectral distribution. The plurality of LEDs 13 may be controllable with respect to characteristics or properties of light emitted by the plurality of LEDs 13. For example, the intensity of the plurality of LEDs 13 may be controlled. According to another example, the spectral distribution of the plurality of LEDs 13 may be controlled. The plurality of LEDs 13 may be controlled by the controller 6. The controller 6 may be configured to control each of the plurality of LEDs 13 individually. The controller 6 may be configured to control the plurality of LEDs 13 together.

The communication element 14 is mechanically coupled to the LED-filament 11. The communication element 14 is configured for wireless communication. The communication element 14 may for example be arranged for, or capable of, radio frequency, RF, wireless communication. Hence, the communication element 14 may comprise at least one RF antenna element. However, the communication element 14 is not limited thereto. In alternative or in addition the communication element 14 may for example comprise at least one infrared antenna.

The communication element 14 may be communicatively coupled to the controller 6. The communication element 14 may be communicatively coupled to the controller 6 by means of a wired and/or wireless communication link as known in the art. The communication link may be direct. Alternatively, the communication link may possibly be via an intermediate communication module (not shown). Via the communication link between the communication element 14 and the controller 6 signals, commands, data, etc. may be transmitted between the communication element 14 and the controller 6.

The controller 6 may be configured to receive a control signal from the communication element 14 for controlling operation of the plurality of LEDs 13. The control signal may have been received by means of wireless communication by the communication element 14. The control signal may for example have been transmitted to the communication element 14 by a control device or lighting system controller (not shown). The plurality of LEDs (13) may thereby be controlled with respect to operation thereof, for example with respect to dimming and color setting, and/or another or other properties of the emitted light from the LED-filament (11).

The communication element 14 may optionally be configured to transmit signals, commands, data, etc. Such signals, commands, data, etc. may e.g. relate to characteristics of light emitted by the LED-filament. Moreover, such signals, commands, data, etc. may be directed towards a control device or lighting system controller with which the communication element 14 may be communicatively coupled.

FIGS. 2A-D are schematic sectional views of LED-filaments 11 in accordance with respective embodiments of the present invention. Each of FIGS. 2A-D illustrates a cross section of the respective LED-filament 11 in a plane perpendicular to the elongation axis A of the respective LED-filament 11. Common for all embodiments of FIGS. 2A-D is that the communication element is arranged on the substrate 12. By this the LED-filament 11 may be manufactured with relative ease. For example, the communication element 14 may be printed onto the substrate 12. Moreover, by arranging the communication element 14 on the substrate 12 a well-defined position for the communication element 14 may be achieved.

The plurality of LEDs 13 and the communication element 14 may be arranged on a common surface of the substrate 12; see FIG. 2A. The substrate 12 may comprise first and second surfaces, wherein the plurality of LEDs 13 is arranged on the first surface of the substrate 12. The communication element 14 may be arranged on the second surface of the substrate 12. This is illustrated in FIGS. 2B-D. The first and second surfaces may be opposite each other; see FIG. 2B. Hence, the communication element 14 is arranged on a surface of the substrate 12 being opposite the surface onto which the plurality of LEDs is arranged. The second surface may be a side surface of the substrate 12, the side surface being a surface connecting two opposite surfaces of the substrate 12 wherein the first surface is one of the opposite surfaces; see FIG. 2C. The communication element 14 may be arranged on two or more surfaces of the substrate 12; see FIG. 2D. As shown in FIG. 2A-D, the communication element (14) is different from the wiring (15).

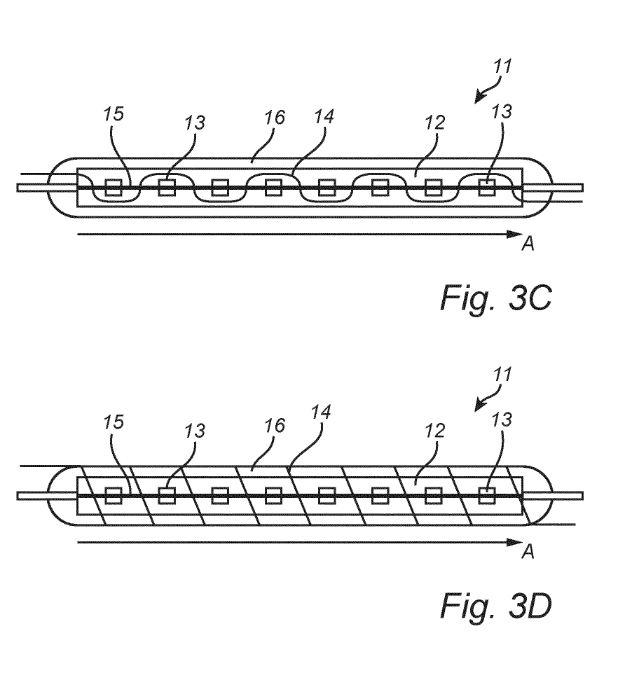

FIGS. 3A-D are schematic side views of a LED-filaments 11 in accordance with embodiments of the present invention.

As illustrated in FIG. 3A the communication element 14 may have an extension parallel with the elongation axis.

Moreover, as illustrated in FIG. 3B the communication element 14 at least partly surrounds the plurality of LEDs 13. A communication element 14 having an extension being longer than the extension of the LED-filament 11 is provided.

The communication element 14 may be configured having a meandering form. For example, the communication element 14 may be configured to have a meandering extension along the elongation axis A. This is illustrated in FIG. 3C. By this, a communication element 14 having an extension being longer than the extension of the LED-filament 11 is provided.

The communication element 14 may be at least in part flexible. That is, at least a portion of the communication element 14 may be flexible. By this, at least a portion of the communication element 14 may be configured to permit winding of that portion of the communication element 14 around another element or component, possibly in a plurality of windings. Hence, the at least a portion of the communication element 14 may be wound around another element or component. For example, the communication element 14 may, at least in part, be wounded around an encapsulation 16 encapsulating the substrate 12 and the plurality of LEDs 13. This is illustrated in FIG. 3D. By this, a communication element 14 having an extension being longer than the extension of the LED-filament 11 is provided.

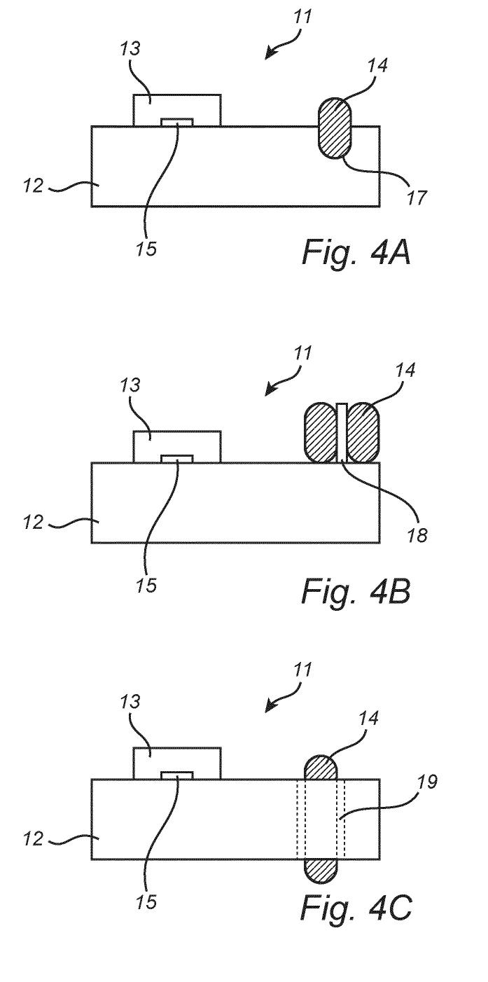

FIGS. 4A-C are schematic sectional views of LED-filaments in accordance with respective embodiments of the present invention. Each of FIGS. 4A-C illustrates a cross section of the respective LED-filament in a plane perpendicular to a elongation axis of the respective LED-filament.

At least a portion of the communication element 14 may be embedded in a groove 17 of the substrate 12; see FIG. 4A. For example, the communication element may be pressed—possibly at relatively high temperature—into the outer surface of the substrate, thereby forming the groove 17 in the substrate 12. The groove 17, and thus also the at least a portion of the communication element 14 embedded in groove 17, may be extending along the elongation axis A.

The substrate 12 may further comprise a protrusion 18. The protrusion 18 may be arranged to support the communication element 14; see FIG. 4B. The protrusion 18 may be arranged to support the communication element 14 on one of the protrusion 18. The protrusion 18 may be arranged to support the communication element 14 on a plurality of sides of the protrusion 18; see FIG. 4B.

The substrate 12 may further comprise a through hole 19. The through hole 19 may be arranged to support the communication element 14; see FIG. 4C. Hence, the communication element 14 may be arranged in the through hole 19.

The substrate 12 may also comprise a plurality of holes. At least some of the holes transmit light from the LEDs positioned on the first surface in the direction of the second surface.

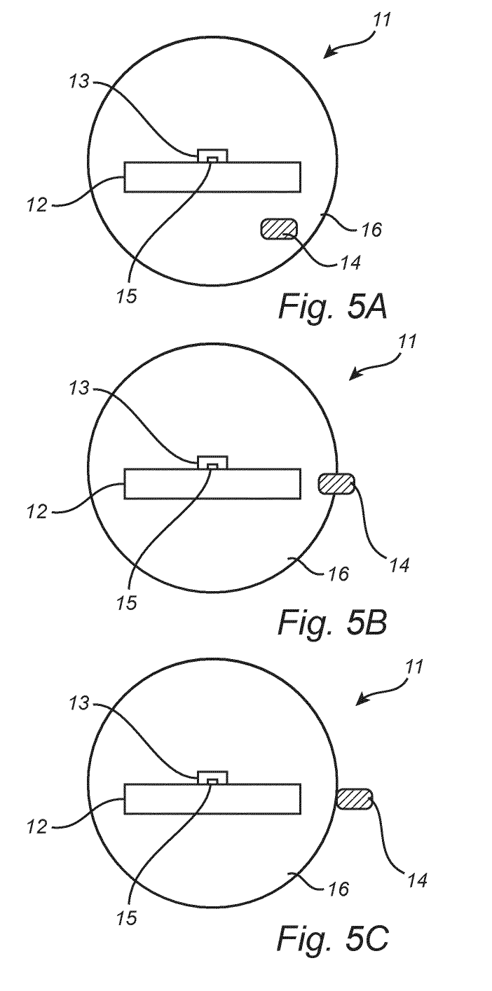

FIGS. 5A-C are schematic sectional views of LED-filaments 11 in accordance with respective embodiments of the present invention. Each of FIGS. 5A-C illustrates a cross section of the respective LED-filament 11 in a plane perpendicular to a elongation axis of the respective LED-filament 11.

As mentioned above, the LED-filament 11 may comprise an encapsulation 16 encapsulating the substrate 12 and the plurality of LEDs 13. The encapsulation 16 may comprise wavelength converting material. The wavelength converting material may be an inorganic material or an organic material. Examples of inorganic wavelength converting materials may include, but are not limited to, cerium (Ce) doped YAG (Y3A15012) or LuAG (LU3AI5O12). Ce doped YAG emits yellowish light, whereas Ce doped LuAG emits yellow-greenish light. Examples of other inorganic phosphors materials which emit red light may include, but are not limited to ECAS (ECAS, which is Cai_xAlSiN3:Eux wherein 0<x<1; preferably 0<x<0.2) and BSSN (BSSNE, which is Ba2-x-zMxSi5-yAlyN8-yOy:Euz wherein M represents Sr or Ca, 0<x<1 and preferably 0<x<0.2, 0<y<4, and 0.0005<z<0.05).

The encapsulation 16 may comprise diffusing elements. The diffusing elements may e.g. comprise scattering particles, such as Al₂O₃ particles, TiO₂ particles and/or BaSO₄ particles. The encapsulation 16 may comprise a glue. Examples of glue include but are not limited to silicone adhesives, epoxy resins, acrylates such as cyanocrylate glues.

At least a portion of the communication element may be integrated within the encapsulation 16; see FIG. 5A. The at least a portion of the communication element 14 integrated within the encapsulation 16, may be extending along the elongation axis A of the LED-filament 11. The at least a portion of the communication element 14 integrated within the encapsulation 16, may be extending along a meandering extension along the elongation axis A of the LED-filament 11.

At least a portion of the communication element 14 may be partly integrated into the encapsulation 16; see FIG. 5B. Hence, the communication element 14 may be embedded in a recess of the encapsulation 16. For example, the communication element 14 may be pressed—possibly at relatively high temperature—into the outer surface of the encapsulation, thereby forming the recess in encapsulation 16.

The at least a portion of the communication element 14 may be wounded around the encapsulation 16.

At least a portion of the communication element 14 may be arranged on the encapsulation 16, see FIG. 5C. According to the above, the at least a portion of the communication element 14 may be wounded around the encapsulation 16.

The at least a portion of the communication element 14 may be glued to the encapsulation 16. However, other means or techniques of coupling or attaching the communication element 14 to, or arranging the communication element 14 on, the encapsulation are possible, as a person skilled in the art will realize.

The person skilled in the art realizes that the present invention by no means is limited to the preferred embodiments described above. On the contrary, many modifications and variations are possible within the scope of the appended claims.

For example, the LED-filament 11 may comprise a plurality of communication elements 14 mechanically coupled thereto. The LED-filament 11 may for example comprise two, three, four or five communication elements 14, or even more, each being mechanically coupled thereto.

The LED-filament 11 may have a cross section in a plane that is substantially perpendicular to the elongation axis of the LED-filament 11 that is circular, or substantially circular. However, it is to be understood that this is according to an example, and that other shapes and geometrical configurations of the LED-filament 11 are possible. For example, the LED-filament 11 may have a cross section in a plane that is substantially perpendicular to the elongation axis of the LED-filament 11 that is oval, or substantially oval.

Moreover, in case the lighting device 1 comprises a plurality of LED-filaments 11, the communication elements 14 of the plurality of LED-filaments 11 may be interconnected forming a common communication element.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A LED-filament comprising:
a substrate having an elongated body with an extension along an elongation axis (A);
a plurality of LEDs mechanically coupled to the substrate;
wiring for powering the plurality of LEDs; and
a communication element mechanically coupled to the LED-filament, the communication element is configured for wireless communication; and
wherein the communication element is different from the wiring;
wherein the LED-filament further comprises an encapsulation encapsulating the substrate and the plurality of LEDs, wherein the communication element is integrated within the encapsulation, partly integrated into the encapsulation, or arranged on the encapsulation; and
wherein the encapsulant comprises a wavelength converting material.

2. The LED-filament according to claim 1, wherein the communication element is arranged on the substrate.

3. The LED-filament according to claim 1, wherein the substrate has first and second surfaces, wherein the plurality of LEDs are arranged on the first surface of the substrate and the communication element is arranged on the second surface of the substrate.

4. The LED-filament according to claim 3, wherein the first and second surfaces are opposite each other.

5. The LED-filament according to claim 1, wherein the plurality of LEDs and the communication element is arranged on a common surface of the substrate.

6. The LED-filament according to claim 1, wherein the substrate comprises a groove, a through hole, or a protrusion, wherein the communication element is arranged in the groove, in through hole, or on the protrusion.

7. (canceled)

8. The LED-filament according to claim 1, wherein the plurality of LEDs are arranged along a line having an extension parallel with the elongation axis (A).

9. The LED-filament according to claim 1, wherein the communication element is positioned other than directly opposite any one of the plurality of LEDs, or other than on top of any one of the plurality of LEDs.

10. The LED-filament according to claim 1, wherein the communication element is having an extension parallel with the elongation axis (A).

11. The LED-filament (11) according to claim 1, wherein the communication element at least partly surrounds the plurality of LEDs.

12. The LED-filament according to claim 1, wherein the communication element is having a meandering extension along the elongation axis (A).

13. The LED-filament according to claim 1, wherein the LED-filament further comprises an encapsulation encapsulating the substrate and the plurality of LEDs, wherein the communication element is wounded around the encapsulation.

14. A lighting device comprising:
a LED-filament according to claim 1; and
a controller configured to control the LED-filament with respect to characteristics of light emitted by the LED-filament,
wherein the communication element is communicatively coupled to the controller, and
wherein the controller is configured to receive a control signal from the communication element for controlling operation of the LED-filament.

15. The lighting device according to claim 13 comprising a plurality of LED-filaments, wherein the communication elements of the plurality of LED-filaments are interconnected forming a common communication element.
